(19) United States
(12) Patent Application Publication
(10) Pub. No.: US 2026/0178760 A1
(43) Pub. Date: Jun. 25, 2026

(54) USER INPUT JSON PARSER

(71) Applicant: Palo Alto Networks, Inc., Santa Clara, CA (US)

(72) Inventors: Jesse Mie Kim, Palo Alto, CA (US); Anirudh Mittal, San Jose, CA (US)

(21) Appl. No.: 18/988,554

(22) Filed: Dec. 19, 2024

(51) Int. Cl. G06F 21/62

(52) U.S. Cl. CPC G06F 21/6218

(57) ABSTRACT

Various techniques for parsing user input JavaScript Object Notation (JSON) are disclosed. In some embodiments, a system, process, and/or computer product for parsing user input JSON includes receiving structured data associated with a Generative Artificial Intelligence application or site (GenAI app/site) backend; processing the structured data using an input parsing model to identify one or more keywords associated with user input; extracting the user input using the one or more identified keywords; determining whether at least a portion of the extracted user input includes content that is to be blocked based on data loss prevention (DLP) policies; and in response to a determination that at least a portion of the extracted user input includes the content that is to be blocked, applying policies to the structured data.

### BACKGROUND OF THE INVENTION

Generative AI Apps (Gen AI Apps) leveraging Large Language Models (LLMs) have become increasingly popular and accessible to the public, allowing users to do anything from asking questions to getting help writing code. In order for the models to maintain efficacy, training data can be taken from user input, meaning that users have to be careful not to send sensitive information which could get used or trained on. Bad actors have been able to extract training data from these LLMs, as vulnerabilities exist within the systems, potentially leading to the leakage of sensitive information put into the LLM.

### BRIEF DESCRIPTION OF THE DRAWINGS

Various embodiments of the invention are disclosed in the following detailed description and the accompanying drawings.

FIG. 1 is a block diagram illustrating a data loss prevention system in accordance with some embodiments.

FIG. 2 is a flow diagram illustrating a process for preventing data loss associated with structured data in accordance with some embodiments.

FIG. 3 is a flow diagram illustrating a process for labeling a keyword in structured data in accordance with some embodiments.

FIG. 4 is a flow diagram illustrating a process for vectorizing split keywords in accordance with some embodiments.

FIG. 5 is an example of structured data that is forwarded to a Gen AI app/site backend in accordance with some embodiments.

FIG. 6 is an example of flattened structured data that resulted in a negative classification in accordance with some embodiments.

FIG. 7 illustrates structured data that contains user input in its unflattened and flattened forms in accordance with some embodiments.

FIG. 8 is an example of structured data that resulted in an FN classification error in accordance with some embodiments.

FIG. 9A is an example of training data that is used to train an ML model in accordance with some embodiments.

FIG. 9B is an example of training data that is used to train an ML model in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Generative AI applications or sites (Gen AI apps) using Large Language Models (LLMs) are frequently used by users to assist in a variety of tasks. Gen AI apps are often deployed on the Internet and allow users to interact with an LLM through frontend applications. On the Internet, users interact with Gen AI apps by generating a user input and sending the user input to a backend server associated with the Gen AI app. Gen AI apps may be deployed on a website as well.

Users may enter anything into a prompt as the user input. Sometimes, users enter sensitive information into the user prompt. Sensitive information is information that an entity (e.g., company, government, institution, etc.) has an interest in keeping confidential. However, Gen AI apps may use user inputs to train models. Further, malicious parties may be able to access user inputs by infiltrating Gen AI app infrastructure. Thus, when a user input that contains sensitive information is sent to a Gen AI app backend, the sensitive information may be leaked.

When a user input is sent to a Gen AI app backend, it is often embedded in structured data. For example, a user input may be embedded in an HTTP POST request, with a unique structure, which is then sent to a Gen AI app backend. In addition to the user input, structured data often contains copious amounts of data that is unrelated to the user input (e.g., tokens, endpoints, metadata, timestamps, id's, etc.).

In current systems, when this unrelated information is sent to data loss prevention (DLP) services, the DLP will often falsely determine that this information is sensitive leading to large amounts of false positives (FP). For example, current systems may send tokens, associated with a user's session on a Gen AI app, to DLP services which will be falsely flagged as containing sensitive information.

In order to detect sensitive information that is being sent to a Gen AI app, the user input must be extracted from the structured data associated with the Gen AI app. However, the particular structure of the structured data may vary widely depending on the Gen AI app. Even the same Gen AI app provided by the same producer may use structured data that varies from version to version. Furthermore, new Gen AI apps with different structured data are created at a fast rate. Often times the method to extract the user input from the structured data associated with one Gen AI app, or one version of a Gen AI app, cannot be generalized to another Gen AI app, or other versions.

Current solutions employ human resources to manually determine the structure of the structured data associated with the variety of available Gen AI apps and newly released Gen AI apps. After the structure is determined, the user input can be extracted from the structured data. Current solutions are inefficient, labor intensive, and time consuming because they rely on human resources and are not generalizable. Furthermore, efficiencies developed for one Gen AI app may not be applicable to another Gen AI app.

The techniques disclosed herein allow for the generalized extraction of user inputs from structured data associated with Gen AI apps. The techniques disclosed herein can be employed to efficiently extract user inputs from the variety of available Gen AI apps and from any new Gen AI apps. Once the user input is extracted, DLP policies can be applied to determine if the user inputs contain sensitive information. Based on the application of the DLP policies, the structured data may be blocked from being sent to the Gen AI App or allowed to be sent.

Structured data associated with a Gen AI app is received from a user interacting with a Gen AI app/site. The structured data is processed using an input parsing model to identify one or more keywords associated with the user input. The user input is extracted from the structured data using the one more identified keywords. A DLP system is used to determine whether at least a portion of the extracted user input should be blocked. In response to a determination that at least a portion of the extracted user input includes content that is to be blocked based on DLP policies, an action is performed. The action may comprise blocking the user input from being sent to the Gen AI app backend by blocking the whole structured data.

The techniques disclosed herein improve the efficiency of checking user inputs for sensitive information. The techniques disclosed herein can be generalized to a variety of Gen AI apps/sites and be used for newly created Gen AI apps/sites. Instead of sending the entire structured data to the DLP system, only the user input is sent. This relieves the DLP of unnecessary processing.

Additionally, the techniques disclosed herein reduce the number of false positives (FP) and false negatives (FN). One type of FP is when something not user input (e.g., a timestamp, a session token, etc.) gets classified as user input, extracted, put through DLP services. One type of FN is when the real user input (e.g., a question posed to a Gen AI app) is not extracted and the entire JSON is put through a DLP service. In this case, the DLP service may not detect any user input because the DLP service is prone to failure when it scans entire structured data. This is also undesirable, because the DLP computation for a large amount of data may be costly. Another type of FP is when user input is present in the structured data but information that is not user input is incorrectly labeled as user input and only the incorrectly labeled information is sent to the DLP services. Thus, the user input is completely missed by the DLP service. The techniques disclosed herein limit the occurrence of such types of false classifications.

The techniques disclosed herein also reduce the reliance on human resources for parsing structured data.

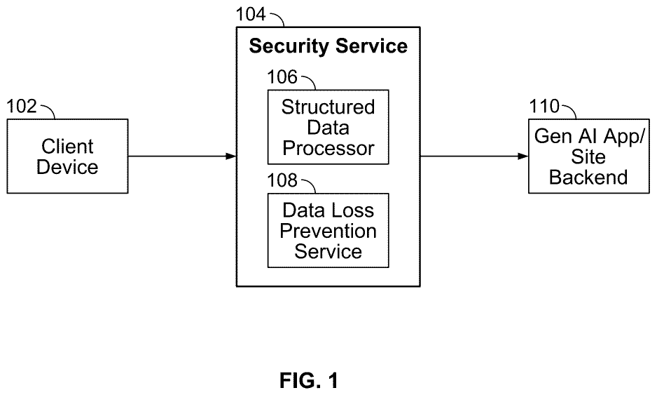

FIG. 1 is a block diagram illustrating a data loss prevention system in accordance with some embodiments. Client device 102 is the device of a user who is interacting with a Gen AI app/site backend 110. Security service 104 intercepts any information that is sent from client device 102 to Gen AI app/site backend 110. Structured data processor 106 uses an input parsing model to extract the user input from the structured data that client device 102 is sending to Gen AI app/site backend 110. After the user input is extracted from the input parsing model, DLP service 108 determines whether or not to apply policies to the structured data, such as blocking the user content from being sent to Gen AI app/site backend 110.

In some embodiments, upon the application of policies by the DLP service, an alert is generated to inform the entity affiliated with security service 104 that sensitive information is detected. Additionally, this alert may include information about the client device 102 associated with the sensitive information.

Client device 102 may be any device which can interface with a Gen AI app/site. Examples include a computer, a laptop, a desktop, a server, a tablet, a smart device, or any other computing device. In some embodiments, client device 102 is provided to a user from an entity (e.g., company, government, institution, etc.). Client device 102 may contain data that is sensitive information for the entity. In some embodiments, client device 102 is used by a user which is associated with an entity (e.g., employee, vendor, consultant, etc.). In some embodiments, the user of client device 102 is privy to sensitive information pertaining to an entity. Sensitive information pertaining to an entity may be any information that the entity has an interest in keeping confidential. Examples include trade secrets, intellectual property, customer information, etc. Sensitive information may also pertain to an individual, such as personally identifying information (PII) e.g., a social-security number.

In some embodiments, client device 102 is interfacing with a Gen AI app/site that is associated with Gen AI app/site backend 110. Client device 102 may be using a frontend service associated with Gen AI app/site backend 110 to send user inputs to Gen AI app/site backend 110. In some embodiments, client device 102 sends user inputs to Gen AI app/site backend 110 without the use of a frontend—for example, through the use of an application program interface (API).

Security service 104 may be any service that can intercept data being transmitted by client device 102. In some embodiments, security service 104 comprises software that is downloaded on client device 102. For example, security service 104 may comprise a virtual private network (VPN) that is installed on client device 102. The VPN may intercept any data that is transmitted to a public network (e.g., the Internet).

In some embodiments, security service 104 comprises a cloud security service. Client device 102 and security service 104 may be configured such that any information transmitted from client device 102 to another destination is intercepted by security service 104.

For example, security service 104 may intercept every network packet that originates from client device 102. To further illustrate, any HTTP request that is sent by client device 102 to the Internet may be intercepted. Thus, security service 104 may be configured to intercept any structured data sent from client device 102 to Gen AI app/site backend 110.

Gen AI app/site backend 110 is the backend of any Gen AI app/site. In some embodiments, Gen AI app/site backend 110 comprises a Large Language Model (LLM). The LLM may be configured to respond to a user input that is generated by client device 102. Examples of well-known Gen AI apps/sites include ChatGPT™, Claude AI™, Google Gemini™, etc. LLMs may respond to user inputs with natural language, e.g., a user may prompt the LLM to help correct the grammar of a sentence.

The Gen AI app/site backend 110 may provide any service to users based on a user input and need not be based on an LLM. For example, Gen AI app/site backend 110 may be associated with a regular Language Model, such as an LSTM, base transformer model, regular expression engines, regular grammar engines etc. Gen AI app/site backend 110 may be any service in which client device 102 may input natural language.

When client device 102 sends Gen AI app/site backend 110 a user input, the user input is embedded within structured data. In some embodiments, the structure of the structured data may be dictated by the Gen AI app/site associated with Gen AI app/site backend 110. In some embodiments, the structured data is created by a frontend that is associated with the Gen AI app/site backend 110.

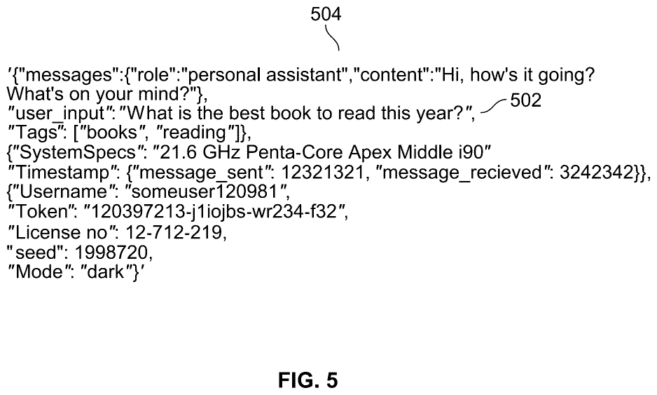

For example, a frontend may comprise a JavaScript-based web application that facilitates a user interacting with the Gen AI app/site backend 110. The frontend may comprise a display with a text input box (e.g., a prompt box) where the user enters a user input. Once the user sends the user input to the Gen AI app/site backend 110 (e.g., by clicking a button), the frontend may process the user input and embed it in structured data (e.g., an HTTP POST Request, HTTP PUT Request, HTTP Request, etc.). The structured data may comprise a markup notation/language such as JavaScript Object Notation (JSON), Extensible Markup Language (XML), Yet Another Markup Language (YAML), Comma Separated Values (CSV), etc. After the frontend creates the structured data, it may forward the structured data to Gen AI app/site backend 110. Security service 104 intercepts the structured data. FIG. 5 illustrates an example of structured data containing the user input “What is the best book to read this year?”

Security service 104 comprises structured data processor 106. Any data that is intercepted by security service 104 may be processed by structured data processor 106. In some embodiments, security service 104 is configured such that any data sent from a client device 102 to any Gen AI app/site backend 110 is processed by structured data processor 106.

Structured data processor 106 extracts user inputs from any structured data. In some embodiments, the structure of the structured data that is sent to Gen AI app/site backend 110 comprises a keyword-value scheme. The user input may be a value associated with one or more keywords. In some embodiments, structured data processor 106 determines one or more keywords that are associated with the user input and extracts the user input using the keyword (e.g., by parsing/querying the structured data).

In some embodiments, the structured data is nested with multiple levels (e.g., a dictionary within a dictionary within a dictionary . . . , a hash table within a hash table within a hash table . . . ). The user input may be deeply embedded within structured data.

Many characteristics of the structured data may be specific to a particular Gen AI app/site. For example, in a keyword-value scheme, the keyword associated with the user input can be highly variable (e.g., “user_input,” “user_prompt,” “user_query,” “query,” “prompt,” “input,” “params/value/content,” “blocks”). Other examples include the location of the user input within the structured data, the nesting pattern of the structured data, if various metadata may be present in the structured data, etc.

In some embodiments, structured data processor 106 flattens the structured data. For example, where the structured data is nested JSON, structured data processor 106 transforms the nested JSON objects into a flat, single-level structure, where each nested keyword may be represented by a concatenated path. In some embodiments, the flattened structured data can be readily queried with a keyword and can return the value associated with the keyword.

In some embodiments, prior to flattening structured data, information associated with the hierarchical position of each keyword is determined and stored for use in a future process.

After flattening the data structure, structured data processor 106 may split the keywords from the values. Structured data processor 106 may generate a list of all the keywords within the structured data. The split keywords are vectorized using any appropriate vectorizing method. Examples of vectorizing methods include one-hot encoding, Bag of Words, TF-IDF, Word2Vec, FastText, GloVe, transformers (BERT, GPT), Doc2Vec, Sentence Transformers (SBERT), etc.

In some embodiments, the position of the keyword within the structured content is used to vectorize the keyword. For example, the number of levels down a keyword that are embedded within the structured content may be represented as numbers. The vectorized keyword may comprise these numbers.

Each vectorized keyword may be queried on a machine learning (ML) model that is configured to return a probability associated with each keyword. The returned probability comprises the likelihood that the keyword is associated with a value which comprises the user input. In some embodiments, the keyword with the highest probability is labeled. Labeling the keyword may comprise flagging the keyword. Labeling the keyword may comprise labeling the keyword as positive. In some embodiments, one or more keywords with high probabilities of being associated with a user input are labeled.

In some embodiments, a score associated with each keyword is generated. The score comprises the probability that each keyword is associated with a user input. One or more keywords with the highest scores may be labeled.

In some embodiments, one or more keywords that have been labeled are used to extract the user input from the structured data. In some embodiments, the flattened structured data can be queried to receive the user input. For example, assuming that the flattened structured data is JSON, the one or more keywords can be queried on the structured data to extract the user input, using any implementation of a JSON parser.

In some embodiments, data loss prevention service 108 applies policies to the user input extracted by structured data processor 106. Data loss prevention service 108 may be any implementation of a data loss prevention scheme. Data loss prevention service 108 may be implemented by an entity associated with security service 104 to prevent the exfiltration of sensitive information from client device 102 to Gen AI app/site backend 110.

Because the user input has been extracted, instead of sending all of the structured data to data loss prevention service 108, only data that contains data that is relevant to data loss prevention is processed by data loss prevention service 108. Minimizing the data that is processed by data loss prevention service 108 is highly advantageous. This is because data loss prevention service 108 may be checking data against a large amount of data (e.g., the entirety of an entity's confidential information). This reduces the latency for executing data loss prevention and the load on data loss prevention service 108.

In response to a determination that at least a portion of user input contains sensitive information, data loss prevention service 108 is configured to apply policies to the structured data. In some embodiments, applying policies comprises performing an action. For example, if it is determined that client device 102 sent a user input to Gen AI app/site backend 110 that contained sensitive information, data loss prevention service 108 can apply a policy which effectively blocks the structured data from being sent to Gen AI app/site backend 110. In some embodiments, security service 104 is configured to effectuate the policies applied by data loss prevention service 108.

To illustrate, suppose a user of client device 102 is an employee of a tech company. The user is using client device 102 to write code for the tech company's proprietary software. In an effort to fix a bug, the user navigates to a Gen AI app/site frontend and uses a copied & pasted block of proprietary code as the user input. The tech company employee then attempts to send the user input to the Gen AI app/site backend 110. The Gen AI app/site frontend nests the user input in a structured data e.g., an HTTP POST Request, an HTTP PUT Request, an HTTP Request, etc. Security service 104 intercepts the structured data. Structured data processor 106 determines the one or more keywords associated with the user input. In this example, there may be more than one keyword associated with the user input because the user copied & pasted a large block of propriety code. Using the one or more keywords associated with the user input, structured data processor 106 extracts the user input which comprises the proprietary block of pasted code. Data loss prevention service 108 determines that the user input contains the proprietary block of pasted code, which is considered sensitive information by the tech company. Data loss prevention service 108 applies policies to the structured data. Now, based on the policies, security service 104 blocks the structured data from being sent to the Gen AI app/site backend 110. Thus, the tech company employee's exfiltration of the propriety block of copy & pasted code is prevented.

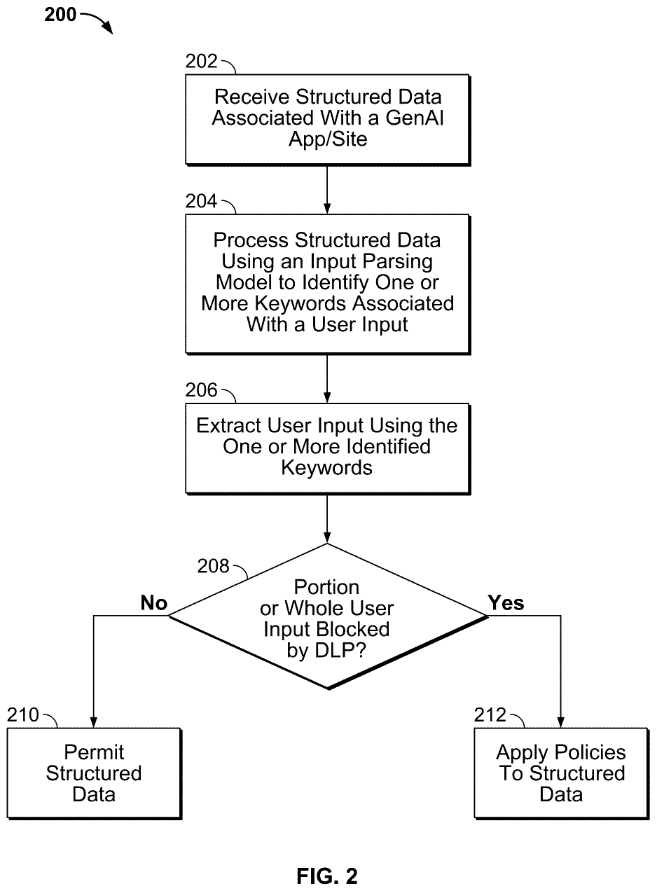

FIG. 2 is a flow diagram illustrating a process for preventing data loss associated with structured data in accordance with some embodiments. In some embodiments, process 200 is executed by a security service.

At 202, structured data associated with a Gen AI app/site is received. The structured data may be received from any source such as a client device. The structured data may be structured in any manner. In some embodiments, the structured data is sent from an interface associated with the Gen AI app/site backend which structures the data in a particular manner.

In some embodiments, the characteristics of the structured data is dependent on the Gen AI app/site backend that it is associated with. For example, in a keyword-value scheme, the keyword associated with the user input can be highly variable. Other examples include the location of the user input within the structured data, the nesting pattern of the structured data, various metadata that may be present in the structured data, etc.

In some embodiments, the structured data is structured by a frontend application associated with a Gen AI app/site. In some embodiments, the structured data is structured by an API associated with the Gen AI app/site backend. For example, a user input may be sent to a Gen AI app/site on the command line through the use of an API (e.g., a CURL request). The API may embed the user input in structured data.

At 204, the structured data is processed using an input parsing model to identify one or more keywords associated with a user input. FIG. 5 illustrates an example of structured data containing the user input “What is the best book to read this year?” In this example, the keyword is “user_input.” After step 204, the keyword “user_input” will be known.

In some embodiments, step 204 identifies multiple keywords which are associated with user input. In some embodiments, there may be one or more keywords which comprise user input. For example, the Gen AI app/site may be configured to send large user inputs using multiple keywords, e.g., “user_input_1,” “user_input_2,” “user_input_3,” . . . In another example, the Gen AI app/site may structure data such that there are multiple keywords associated with the user input.

In some embodiments, keywords that are highly unlikely to contain user input may be filtered out using a rule-based system. For example, any keyword comprising “tags” may be filtered out. The rule-based system may also filter based on the values associated with the keywords. For example, if the value associated with keyword contains nothing (e.g., “NA”, whitespace”, blank value, etc.) than the keyword may be filtered out.

In some embodiments, all keywords present in the structured data are associated with a probability that indicates the probability that the keyword is associated with a user input. In some embodiments, a score associated with each keyword is generated. The score comprises the probability that each keyword is associated with a user input. One or more keywords with the highest scores may be labeled. In some embodiments, the keywords with associated probabilities/scores over a certain threshold value are identified. For example, step 204 may identify all keywords with associated probabilities indicating a greater than 80% chance that the keyword is associated with a user input.

At step 206, the user input is extracted using the one or more identified keywords. In some embodiments, previous steps provide a modified version of the structured data (e.g., a flattened JSON). Thus, after the one or more keywords which are associated with user input have been identified, a common implementation of a parser associated with the structured data or the modified structured data may be utilized to extract the user input using the keywords. For example, a JSON parser (e.g., a JSON encoder/decoder) can query the structured data with the keyword and the user input will be returned. In some embodiments, an input parsing model is comprised of an ML model that is trained on structured data associated with one or more of a plurality of GenAI apps/sites

In some embodiments, the keywords labeled with a label indicative of the keyword's association with a user input (e.g., 1) are used to extract the user input associated with that keyword. In some embodiments, the previously produced data is used to extract the user input associated with a keyword. For example, after some processing is performed on the structured data (e.g., flattening, aggregating, etc.), the processed structured data may be queried with the keyword and the user input acquired.

In some embodiments, the structured data can be queried/parsed to extract the user input associated with a keyword. For example, when the structured data is JSON, any implementation of a JSON parser may be used to extract the user input associated with the keyword.

At 208, it is determined whether a portion or the whole of the user input is blocked by a data loss prevention service. A data loss prevention (DLP) service may be employed to check data for sensitive information that an entity has an interest in keeping confidential. Examples are trade secrets or proprietary code. In some embodiments, the whole user input is sensitive information and is determined to be blocked by the data loss prevention service. In some embodiments, a security service effectuates the policies applied by the DLP service.

In some embodiments, policies effectuated by a security service comprise blocking the entire structured data (e.g., the entire HTTP Request) from being sent to a Gen AI app/site backend. In some embodiments, the entity associated with a security service may define how policies are applied by configuring the security service. For example, the entity may configure the security service to completely block the entire structured data if the DLP services determines that the structured data contains highly sensitive information, but only issue an alert if the structured data contains less sensitive information.

In some embodiments, a portion of the user input is determined to be blocked by the DLP service. In some embodiments, the DLP service will apply policies based on the amount of the user input that is sensitive information. In some embodiments, the entity associated with the DLP service may set a threshold value for the application of DLP policies. For example, the entity may configure the DLP service to apply policies to any user input that contains a 50% match to sensitive information. Any scheme of DLP may be used at step 208 to determine whether DLP policies should be applied to the user input.

In response to a determination that DLP policies should be applied to the user input, process 200 proceeds to 212. In response to a determination that DLP policies do not need to be applied to the user input, process 200 proceeds to 210.

At 210, structured data is permitted. The structured data may be permitted to be sent to a Gen AI app/site backend. In some embodiments, a security service allows the structured data to be sent to the Gen AI app/site backend. In this case, it has been determined that the user input does not contain sensitive information, so the structured data containing the user input may proceed without the applications of DLP policies.

At 212, policies are applied to the structured data. Policies may comprise any DLP related policies. For example, the policies may be such that the structured data is blocked from being forwarded to the destination it is initially sent to. Policies may refer to security policies, such as preventing the sending of a data in a secret file. In some embodiments, the application of policies prevents a client device sending sensitive information to a Gen AI app/site backend.

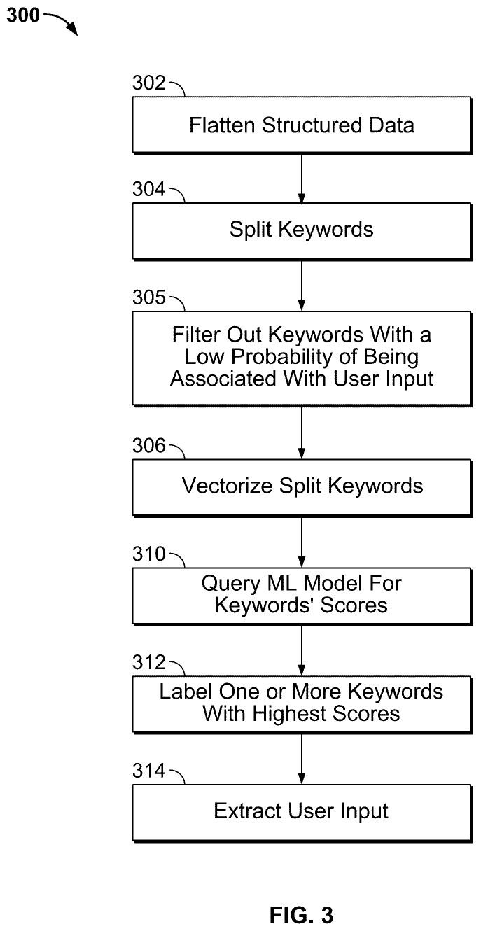

FIG. 3 is a flow diagram illustrating a process for labeling a keyword in structured data in accordance with some embodiments. Step 204 may be implemented in whole or in part by process 300.

In some embodiments, where the structured data is not formatted in JSON (e.g., it is formatted in lists, lists of JSONs, encoded JSONs, base64 encoded JSONs, URL encoded JSONs, YAML, XML, CSV, etc.), the structured data may be preformatted into JSON. This is a simple process and may be done by many known methods.

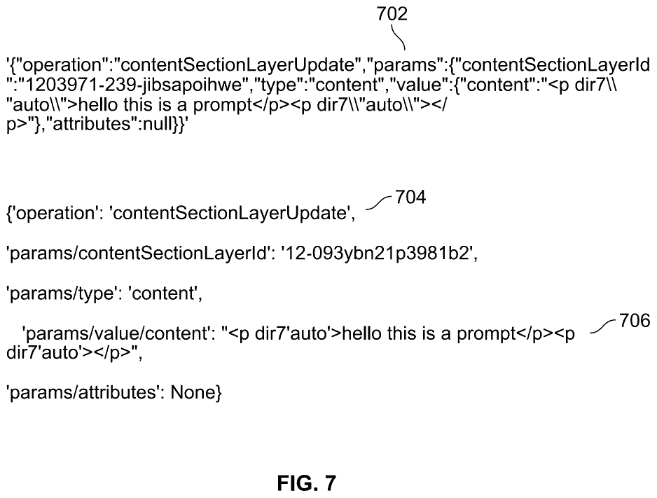

At 302, the structured data is flattened. In some embodiments, the structured data is flattened into a table such that every keyword within the nested data is represented as a row in a column containing the keywords. The row is associated with a second and third column where the second column comprises words that the keyword is comprised of, and the third column contains a value which is associated with the keyword. FIG. 7 is illustrative of unflattening structured data.

At 304, the keywords are split from the rest of the structured data. In some embodiments, step 304 produces a list of keywords. For example, step 304 may extract the keyword and word column of the table produced in step 302.

At 305, keywords with a low probability of being associated with user input are filtered out. In some embodiments, keywords that comprise words with a low probability of being associated with a user input are filtered out. For example, “tags” are often used in structured data and are highly unlikely to contain user input. In another example, the keyword may be “tags_of_list.” The keyword contains the word “tags” and may be filtered out for similar reasons as filtering out the keyword “tag.” In some embodiments, step 305 is optional.

At 306, the split keywords are vectorized. The keywords may be vectorized in any method. Examples of vectorizing methods include one-hot encoding, Bag of Words, TF-IDF, Word2Vec, FastText, GloVe, transformers (BERT, GPT), Doc2Vec, Sentence Transformers (SBERT), etc. In some embodiments, vectorization of the keywords comprises a multi-step process.

In some embodiments, vectorization of the keywords also comprises vectorizing the words comprising the keyword. For example, suppose the keyword is “user_input.” The words comprising the keywords may be “user” and “input.” In some embodiments, the words associated with the keywords are used in the process of vectorizing the keywords.

At 310, an ML model is queried for keywords'scores. In some embodiments, the ML model may be any model that can be queried with a vectorized keyword. In some embodiments, the ML model is trained on a plurality of keywords within structured data. Each training keyword is associated with a score indicative of the likelihood that the keyword is associated with a user input. The ML model may be trained in a supervised manner such that it may be queried at a future time with a keyword and generate a keyword score.

The keyword score is any metric that is indicative of the keyword's association with a user input. In some embodiments, the keyword score comprises the probability that the keyword is associated with a user input. For example, the keyword “user_input” may be given a score of 0.89 while the keyword “SystemSpecs” may be given a score of 0.11. In this example, the higher score indicates a higher probability that the keyword is associated with a user input.

In some embodiments, training data for the ML model is produced from gathering structured data from Gen AI apps/sites where the keyword associated with the user input is known. Keywords within the structured data are vectorized and labeled to produce a training set for supervised learning.

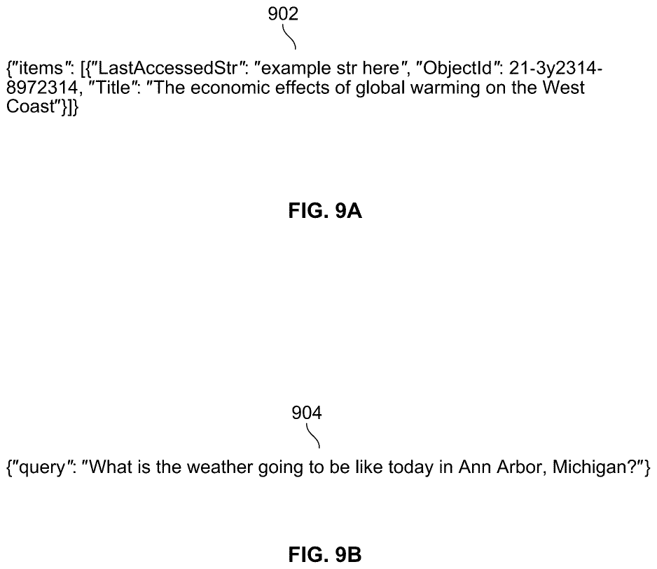

In some embodiments, training data is produced by sending a known user input to a plurality of Gen AI apps/sites and using string location methods (e.g., regex) to extract the keyword associated with the known user input for the Gen AI app/site. The keywords are then classified by whether or not they are associated with user input. The keywords and their scores are aggregated. The aggregation of the keywords and their scores are then used to train an ML model using any reinforcement learning scheme. Examples of training data are shown in FIG. 9A and FIG. 9B.

In some embodiments, training the ML model comprises validation from human annotators.

In some embodiments, the ML model is implemented using Keras™. The model may comprise a four Layer dense NN (e.g., generated by “keras. models import Sequential”). In some embodiments, the first three layers have sizes and activation+dropout percentages based on hyperparameter tuning. In some embodiments, hyperparameter tuning depends on which combination gives the best performance on a validation set. In some embodiments, the last layer is a sigmoid activation of size 2 that is associated with a binary classification for each keyword. The binary classification classifies the keyword based on whether it is associated with a user input.

At 312, one or more keywords with the highest scores are labeled. In some embodiments, all the results from querying the ML model are aggregated and sorted based on their scores such that the one or more keywords with the highest scores are on the top of a list. In some embodiments, the one or more keywords with high scores are labeled with a label indicative of being associated with user input while other keywords are labeled with a label indicative of not being associated with user input (e.g., 1 for user input and 0 for not user input).

In some embodiments, labeling is executed such that keywords with a score that exceeds a certain threshold value are labeled with a label indicating they are associated with user input. For example, keywords with a score greater than or equal to the threshold value of 0.7 are labeled with a 1, indicating they are associated with a user input. Additionally, keywords with a score less than the threshold value of 0.7 are labeled with a 0, indicating that they are not associated with a user input.

At 314, the user input is extracted.

After step 314, the user input may be sent to a DLP service.

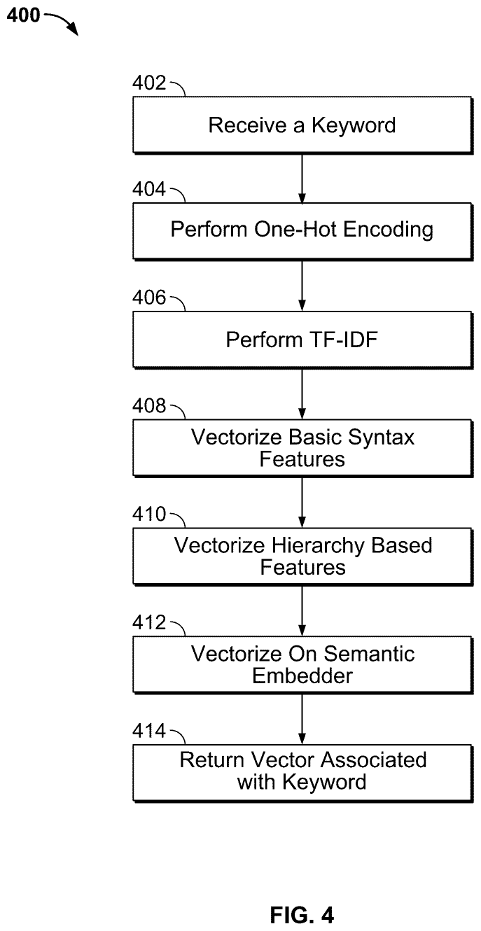

FIG. 4 is a flow diagram illustrating a process for vectorizing split keywords in accordance with some embodiments. In some embodiments, some or all of process 400 is implemented to perform step 306. In some embodiments, process 400 is executed on a security system.

Steps 404-412 may be executed in any order to produce a vector associated with a keyword comprising the result of each step. The resulting vector may be in a specific order that can be readily queried on an ML model trained on vectors with that specific order. For example, the resulting vector from the process is formatted with results of each step in the following order: one-hot encoding, TF-IDF, basic syntax features, hierarchy-based features, and semantic embedder.

In some embodiments, the result of process 400 is a vector with a size N that represents the keyword. The size N vector may then be queried on an ML model that is configured to function on vectors of size N. The vector of size N may be generated by concatenating the results of one or more steps of process 400. The final vector of size N may be put through a model of dense layers specifically tuned to determine if user input is present given a keyword.

At 402, a keyword is received. The keyword may be received from a process that has split keywords from structured data. The structured data associated with the keyword may also be known and used by process 400 to vectorize the keyword.

At step 402, one-hot encoding is performed. Any technique that is used to convert categorical data (e.g., data that can take on a fixed number of values or categories) into a numerical format may be used. In some embodiments, keyword one-hot encoding filters are utilized.

In some embodiments, one-hot encoding is implemented using a bag of words approach. In a bag of words approach, there is a vocabulary list of words that are considered likely to be associated with user input (e.g., “user,” “input,” “prompt,” “query,” “title,” etc.). In response to a determination that one or more of the words within the bag of words is present in the keyword, the result of one-hot encoding is a 1. In response to a determination, that one or more of the words are not present in the bag of words, the result of one-hot encoding is a 0. To further illustrate, the word “timestamp” may be labeled as 0 because it is not within the bag of words. In some embodiments, the word (e.g., “timestamp”) is checked on an array of N words. In response to a determination any of the N words is present in the word, then the word is labeled with a 1.

In some embodiments, one-hot encoding vectorization comprises vectorizing based on positive keyword occurrences and negative keyword occurrences.

In some embodiments, where the keyword contains multiple words, there will be multiple one-hot encoding values associated with the keyword within the vector. For example, if the keyword is “user_input,” there may be a 1 for “user” and a 1 for “input,” thus the one-hot encoding portion of the vector will be 11.

In another example, the multiple words within the keyword are each checked on an array of N words. In response to a determination any of the N words is present in the multiple words of the keyword, then the keyword is labeled with a 1.

At 406, Term Frequency-Inverse Document Frequency (TF-IDF) is performed. TF-IDF may comprise any method that produces a numerical statistic which measures the importance of a word within a document relative to a collection of documents. In some embodiments, the collection of documents comprises a collection of keywords found within structured data associated with a plurality of Gen AI apps/sites.

In some embodiments, TF-IDF vectorization is performed such that highly important keywords to classify on are identified. TF-IDF vectorization may comprise word-based methods for relating keywords containing or not containing user input.

In some embodiments, TF-IDF vectorization training is executed prior to training the overall model. This provides TF-IDF weights for overall model training. During overall model training, a vector will be created based on the words in a keyword. Further, TF-IDF has W words in its vocabulary based on the weights it determines and will give scores to words in a NxW array where N is number of keywords.

At 408, the basic syntax features are vectorized. The basic syntax features may comprise a vectorization for any information on the keyword's structure. For example, the length of the word(s) within the keyword may be vectorized. The number of words within the keywords may also be vectorized.

At 410, hierarchy-based features are vectorized. Hierarchy-based features are any features associated with the position of the keyword within structured data. Hierarchy-based features are vectorized such that the hierarchical nature of the structured data is accounted for. This is useful because user input may occur in similar positions within various structured data associated with various Gen AI apps/sites.

For example, the number of keywords preceding the keyword within the structured data may be vectorized. In another example, data associated with a list within the structured data may be vectorized. A list represents a format of data that can be represented as an array and/or vector of values. In some embodiments, the keyword's position within a list may be vectorized. For example, data representing whether the keyword is at the very beginning of a list or if it's at the very end of a list may be encoded into the resulting vector. In some embodiments, hierarchy-based features comprise the position of the keyword within a list.

The structured data may comprise information that indicates the presence of particular hierarchical features. For example, the structured data indicates that a list is present by containing values that are common methods of denoting lists, e.g., the presence of “tag/0,” “tag/1,” “tag/2,” . . . within the structured data may indicate that there are indices of a list. In some embodiments, where there are indications of a list, the list is extracted and the position of the keyword within the list is determined.

In some embodiments, vectorization of hierarchy-based features comprises other features such as which nested level the keyword resides. In some embodiments, the hierarchy-based features comprise the level at which the keyword is nested within nested structured data.

At 412, the keyword is vectorized on a semantic embedder. The semantic embedder vectorization captures information on the keyword's meaning. A sentence embedding model may be used on the keyword because the keyword associated with the user input will likely contain words which have similar meaning to “user input,” “query,” “prompt,” etc.

Any sentence embedding model which produces semantic similarities in a vectorized form may be used to execute step 412. Examples of common sentence embedding models include Word2Vec, FastText, GloVe, transformers (BERT, GPT), Doc2Vec, Sentence Transformers (SBERT), etc.

At 414, a vector associated with the keyword is returned. The vector associated with the keyword may be a vector of size N. The order of the results of the step may be such that a particular ML model can be queried for a score associated with the keyword. The score may comprise a metric indicating the probability that the keyword is associated with a user input.

FIG. 5 is an example of structured data that is forwarded to a Gen AI app/site backend in accordance with some embodiments. In this example, structured data 504 is in a JSON format.

This example may be produced by a Gen AI app/site frontend when a user enters user input 502 (“What is the best book to read this year?”) into a text input box and performs an action which sends the query to the Gen AI app/site backend (e.g., hitting a “send” button on the frontend). An HTTP POST request comprising structured data 504 may be generated by the Gen AI app/site frontend upon the user sending user input 502. This HTTP POST request may be intercepted by a security service. The payload of the HTTP POST request may comprise structured data 504. In some embodiments, a security system extracts structured data 504 from the payload of an HTTP POST request. User input 502 is embedded in structured data 504. User input 502 may then be extracted from structured data 504 with the application of the techniques disclosed herein.

In this example, user input 502 is a value associated with the keyword “user_input.” However, structured data 504 comprises several other keywords associated with various values that may be unrelated to user input, including “messages,” “content,” “SystemSpecs,” “Username,” “Token,” etc.

In some embodiments, after extracting the structured data 504 from an HTTP POST request payload, structured data 504 is processed using an input parsing model to identify one more keywords associated with a user input (e.g., user input 502). For example, structured data processor 504 is flattened and the keywords (e.g., “user_input,” “messages,” “content,” “SystemSpecs,” “Username,” “Token,” etc.) are split. The split keywords are then vectorized. Each split keyword may be vectorized by applying one-hot encoding, TF-IDF, basic syntax feature vectorization, hierarchy-based feature vectorization, and sentence embedding vectorization.

TF-IDF vectorization may be comprised of determining each keyword TF-IDF within structured data 504. Hierarchy-based feature vectorization may be comprised of vectorizing based on the position of each keyword within structured data 504. In this example, the keyword “content” is embedded in a second level where the first level is associated with the keyword “messages.” In some embodiments, prior to flattening structured data 504, information associated with the hierarchical position of each keyword is determined such that it can be used in vectorization.

The vectorized keywords are queried on an ML model for a keyword score. The ML model may be comprised of the ML models disclosed herein. One or more keywords are then labeled based on the generated scores with a label indicative of whether or not the keyword is associated with user input (e.g., 1 for associated with user input and 0 for not associated with user input).

For example, the keyword “messages” may be given a score of 0.5, while the keyword “user_input” may be given a score of 0.89. To further illustrate, where the threshold value is set to 0.4 the keywords “messages” and “user_input” are both labeled with a label indicative of the keyword being associated with user input.

User input 502 may then be extracted from structured data 504 using any appropriate method. For example, data produced in a previous step such as a flattened data structure or the associated keywords with their values may be used to extract the associated value. In some embodiments, structured data 504 can be queried/parsed with the keyword to extract the associated value. In this example, structured data 504 is in a JSON format, therefore, with the labeled keywords known, extracting their associated values may be done using any implementation of a JSON parser.

User input 502 may now be sent to a DLP service. Because user input 502 has been extracted, only user input 502 is sent to a DLP service instead of sending all of structured data 504. In this example, structured data 504 comprises a smaller amount of data, however, various Gen AI apps/sites may generate much larger amounts of structured data, such that sending the whole structured data 504 will impact the efficacy of a DLP service.

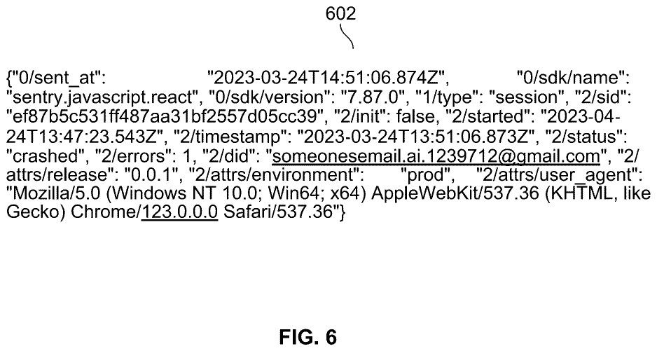

FIG. 6 is an example of flattened structured data that resulted in a negative classification in accordance with some embodiments. In this example, the techniques disclosed herein will classify flattened structured data 602 as negative for containing any user input. This is because structured data 602 does not contain any keyword indicative of a user input.

When structured data does not contain a keyword indicative of user input it is highly unlikely that sensitive information is contained within the structured data. Thus it is not ideal to send the structured data to a DLP service.

A brute force solution or other current solutions may unnecessarily send structured data 602 to a DLP service. This may impact the efficacy of a security service. For example, structured data 602 may be mistakenly blocked from being sent to a destination because a DLP service may determine that structured data 602 contains sensitive information. This may occur when structured data 602 comprises information (e.g., email, token, etc.) which may generally be considered sensitive by the DLP service. However, in the context of an HTTP request (e.g., POST, PUT, GET, etc.) such information is expected, therefore, generating an alert due to this information may be unwanted behavior.

The techniques disclosed herein can discern that structured data 602 does not contain user input, thus it can determine that structured data 602 does not contain sensitive information that may be found in user input.

In some embodiments, even when it is determined that structured data (e.g., structured data 602) does not contain user input, the structured data is still sent to a DLP service. In some embodiments, a security solution/system is configured such that all structured data is sent to a DLP service. When it is determined that the structured data does not contain user input, the analysis of the structured data by the DLP service may be deemed less critical. Therefore, the structured data may be analyzed without the need to process it further.

FIG. 7 illustrates structured data that contains user input in its unflattened and flattened forms in accordance with some embodiments. FIG. 7 is indicative of the results produced by flattening structured data and structured data that results in a positive determination of comprising user input.

Unflattened structured data 702 is indicative of the original state of structured data as it may be received by a security service and prior to executing a flattening process. In unflattened structured data 702, the keywords are on multiple levels within the structured data. In some embodiments, structural data associated with unflattened structured data 702 is extracted for future use.

A flattening process is executed on unflattened structured data 702 to produce flattened structured data 704. Flattened structured data 704 may then be used to split keywords from the structured data. In this example, the keywords comprise “operation,” “params/contentSectionLayerId,” “params/type,” “params/value/content,” and “params/attributes.” In this example, the keyword “params/value/content” is associated with a value comprising a user input 706 “<p dir7‘auto’>hello this is a prompt</p><p dir7‘auto’></p>.” The techniques disclosed herein are used to determine that the “params/value/content” keyword is associated with user input 706. Further, user input 706 is extracted for use on a DLP service.

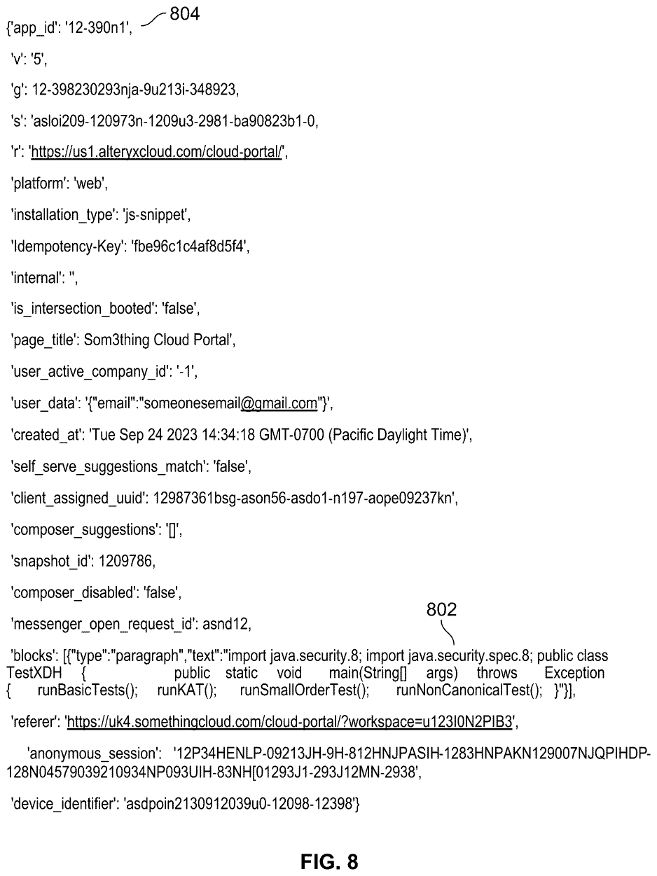

FIG. 8 is an example of structured data that resulted in an FN classification error in accordance with some embodiments. The example shown resulted in a false negative (FN) classification error using current solutions. An FN error occurs when it is falsely determined that structured data does not contain user input. In this example, user input 802 comprises Java™ code. User input 802 is embedded in structured data 804.

In this example, the keyword associated with user input 802 is “blocks.”

Current solutions may fail to extract user input 802 from structured data 804 because it is JAVA™ code. Current solutions fail because the DLP service is able to detect JAVA™ code alone, but may be unable to detect JAVA™ code when it is embedded in extraneous structured data (e.g., JSON).

However, the techniques disclosed herein extract user input 802 and send the JAVA™ code to a DLP service without the extraneous structured data. Thus, the DLP service is able to correctly identify the code as JAVA™ code and execute DLP processes associated with JAVA™ code. It is crucial that code is sent to DLP services because code often contains sensitive trade secrets concerning proprietary software.

FIG. 9A is an example of training data that is used to train an ML model in accordance with some embodiments. The keywords “items,” “LastAccessedStr,” “ObjectId,” and “title” may be extracted using methods disclosed herein.

The user input “The economic effects of global warming on the West Coast” is entered and sent to a Gen AI app/site backend and resulting structured data 902 which is created by the Gen AI app/site is extracted using any web developer tool capabilities. Because the user input is known, the keyword associated with the user input can be determined. The keyword associated with the user input is extracted and labeled, and the other keywords are also extracted and labeled. The extracted and labeled keywords may then be vectorized and used to train an ML model. In this example, after training the ML model, the ML model will be able to determine that the keyword “title” is likely associated with user input.

FIG. 9B is an example of training data that is used to train an ML model in accordance with some embodiments. In this example, structured data 904 comprises one keyword, “query.” The ML model can be trained on this keyword.

FIG. 9A and FIG. 9B are only two examples of training data. However, the ML model disclosed herein may be trained on a plurality of structured data in a similar manner as described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving structured data associated with a Generative Artificial Intelligence application or site (GenAI app/site) backend;
processing the structured data using an input parsing model to identify one or more keywords associated with user input;
extracting the user input using the one or more identified keywords;
determining whether at least a portion of the extracted user input includes content that is to be blocked based on data loss prevention (DLP) policies; and
in response to a determination that at least a portion of the extracted user input includes the content that is to be blocked, applying policies to the structured data.

2. The method of claim 1, wherein the DLP policies detect sensitive information.

3. The method in claim 1, wherein processing the structured data using the input parsing model to identify the one or more keywords associated with user input further comprises:
flattening the structured data;
splitting keywords within the flattened structured data;
filtering out keywords with a low probability of being associated with the user input;
vectorizing the split keywords;
querying a machine learning (ML) model for scores for the keywords;
labeling one or more of the keywords with highest scores; and
extracting user input.

4. The method in claim 3, wherein the ML model that is queried for the scores for the keywords is trained on a plurality of structured data associated with a plurality of Gen AI apps/sites.

5. The method in claim 3, wherein the scores for the keywords comprise a probability that a keyword is associated with the user input.

6. The method in claim 3, wherein the keywords are labeled based on a determination of whether their scores meet or exceed a threshold value.

7. The method in claim 3, wherein vectorizing the split keywords further comprises:
receiving a keyword;
performing one-hot encoding on the keyword;
performing term frequency-inverse document frequency (TF-IDF) on the keyword;
vectorizing basic syntax features of the keyword;
vectorizing hierarchy-based features of the keyword;
vectorizing the keyword on a semantic embedder; and
returning a vector associated with the keyword.

8. The method of claim 7, wherein the hierarchy-based features comprise a position of the keyword within a list.

9. The method of claim 7, wherein the hierarchy-based features comprise a level at which the keyword is nested within a nested structured data.

10. The method of claim 7, wherein the basic syntax features comprise a length of a word(s) comprising the keyword and a number of words comprising the keyword.

11. A system, comprising:
a processor configured to:
receive structured data associated with a GenAI app/site backend;
process the structured data using an input parsing model to identify one or more keywords associated with user input;
extract the user input using the one or more identified keywords;
determine whether at least a portion of the extracted user input includes content that is to be blocked based on DLP policies; and
in response to a determination at least portion of the extracted user input includes the content that is to be blocked, apply policies to the structured data; and a memory coupled to the processor and configured to provide the processor with instructions.

12. The system of claim 11, wherein the DLP policies detect sensitive information.

13. The system of claim 11, wherein process the structured data using an input parsing model to identify one or more keywords associated with user input further comprises:
flatten the structured data;
split keywords within the flattened structured data;
filter out keywords with a low probability of being associated with the user input;
vectorize the split keywords;
query a machine learning (ML) model for scores for the keywords;
label one or more of the keywords with highest scores; and
extract user input.

14. The system of claim 13, wherein the ML model that is queried for scores for the keywords is trained on a plurality of structured data associated with a plurality of Gen AI apps/sites.

15. The system of claim 13, wherein scores for the keywords comprise a probability that a keyword is associated with the user input.

16. The system of claim 13, wherein the keywords are labeled based on a determination of whether their scores meet or exceed a threshold value.

17. The system of claim 13, wherein vectorizing the split keywords further comprises:
receive a keyword;
perform one-hot encoding on the keyword;
perform term frequency-inverse document frequency (TF-IDF) on the keyword;
vectorize basic syntax features of the keyword;
vectorize hierarchy-based features of the keyword;
vectorize the keyword on a semantic embedder; and
return a vector associated with the keyword.

18. The system of claim 17, wherein the hierarchy-based features comprise a position of the keyword within a list.

19. The system of claim 17, wherein the hierarchy-based features comprise a level at which the keyword is nested within a nested structured data.

20. A computer program product embodied in a non-transitory computer readable medium and comprising computer instructions for:
receiving structured data associated with a GenAI app/site backend;
processing the structured data using an input parsing model to identify one or more keywords associated with user input;
extracting the user input using the one or more identified keywords;
determining whether at least a portion of the extracted user input includes content that is to be blocked based on DLP policies; and
in response to a determination that at least a portion of the extracted user input includes the content that is to be blocked, applying policies to the structured data.
